(19) United States
(12) Patent Application Publication
(10) Pub. No.: US 2013/0171375 A1
(43) Pub. Date: Jul. 4, 2013

(54) SMART FILM STRUCTURE

(71) Applicant: Sam YU, Taoyuan City (TW)

(72) Inventor: Sam YU, Taoyuan City (TW)

(73) Assignee: POLYTRON TECHNOLOGIES, INC. and POLYTRONIX, INC.

(21) Appl. No.: 13/341,742

(22) Filed: Dec. 30, 2011

(51) Int. Cl. B32B 15/04; C09K 19/02

(52) U.S. Cl. 428/1.3; 428/457

(57) ABSTRACT

A smart film structure is provided. It includes a light shuttle film, a heat insulating film structure arranged on one surface of the light shuttle film, and an attached layer arranged on another surface of the light shuttle film. This smart film structure is attached to a transparent object by using the attached layer, to change the transparent state of the transparent object at user's own choice. The transparent object may be insulated against heat by means of the heat insulating film structure, so as to lower indoor temperature and reduce the use of air conditioners with the advantage of energy conservation.

### BACKGROUND OF THE INVENTION

1. Field of the Invention

The present invention relates to a smart film structure, more particularly, to a smart film structure with thermal insulation function.

2. Description of the Prior Art

Currently transparent glass curtain walls are adopted for many designs for curtain walls, greenhouses, indoor partition walls or screen partitions for ornamental or lighting purposes, wherein the shielding function of thermal radiation insulation is addressed. For the reason of privacy protection and blocking sunlight, window curtains or dyed glass are usually arranged with transparent glass curtains. However, regular maintenance and extra space for window curtains are necessary and transparency of dyed glass cannot be adjusted freely and thus it is impractical for general use.

In recent years, a type of smart glass is developed and transparency thereof can be adjusted by changing electric current based on the characteristics of the liquid crystal materials arranged inside. Nevertheless, original interior decoration must be damaged for extra installation of smart glass; maintenance or replacement of the glass is difficult. Besides, this type of smart glass is not thermally insulated and useful life thereof is easily affected due to long-term sunlight exposure, which is not in line with user requirements.

### SUMMARY OF THE INVENTION

The present invention is made in view of the aforementioned states of the art and it is an objective of the present invention to provide a smart film structure which can be attached to transparent glass directly to change transparency state of the glass freely with the advantages of blocking sight from outside viewers and protecting privacy; it also can effectively insulate against thermal radiation and conduction from the sun, for lowering indoor temperature or reducing the use of air conditioners to conserve energy.

One objective of the present invention is to provide a smart film structure, which can generate different thermal insulation effects, and different looks of reflection, color and luster effects.

One objective of the present invention is to provide a smart film structure, which can effectively protect human skin and indoor furniture from being damaged by UV light.

In order to achieve the objectives mentioned above, a smart film structure according to an embodiment of the present invention comprises: a light shuttle film including two opposite surfaces; a heat insulating film structure and an attached layer respectively arranged on the two opposite surfaces of the light shuttle film.

The objectives, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a structure schematic diagram of a smart film structure according to an embodiment of the present invention;

FIG. 2 is a structure cross section schematic diagram of a smart film structure according to an embodiment of the present invention; and

FIG. 3 is a structure schematic diagram of a smart film structure according to another embodiment of the present invention.

### DESCRIPTION OF THE PREFERRED EMBODIMENT

The detail description is provided below and the preferred embodiments described are only for the purpose of description rather than for limiting the present invention.

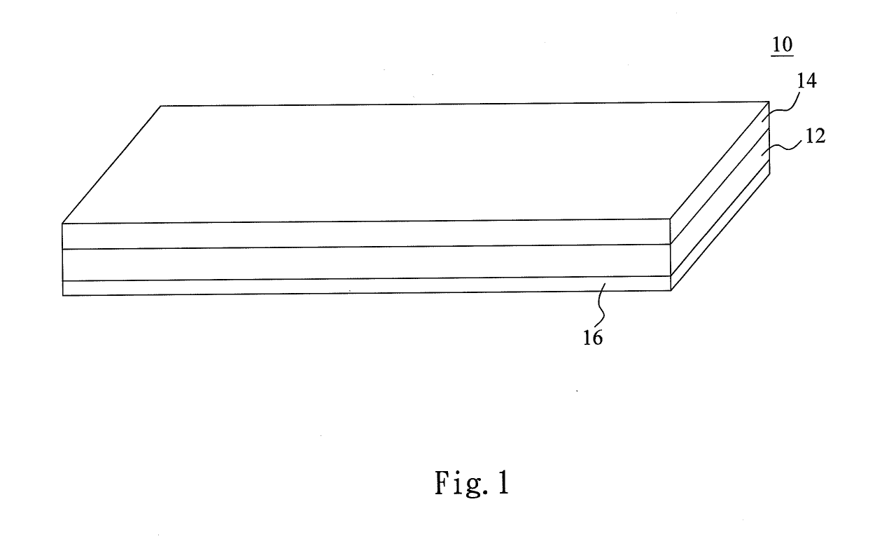

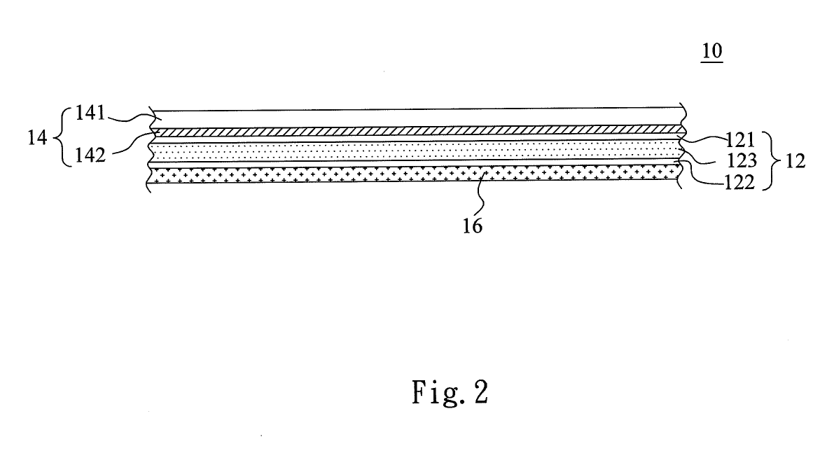

FIG. 1 is a structure schematic diagram of a smart film structure according to an embodiment of the present invention. In this embodiment, the smart film structure 10 comprises: a light shuttle film 12, a heat insulating film structure 14 and an attached layer 16, which are stacked on each other in sequence. Also refer to FIG. 2, a cross section schematic diagram of the smart film structure according to an embodiment of the present structure. In this embodiment, the light shuttle film 12 is a polymeric dispersed liquid crystal (PDLC) film including two parallel and separately arranged transparent substrates, which are a first substrate 121 and a second substrate 122. Two transparent conductive electrode layers (not shown) are respectively arranged on the two opposite inner surfaces of the first substrate 121 and the second substrate 122; a PDLC layer 123 is arranged between the first substrate 121 and the second substrate 122, wherein Indium Tin oxide or Indium Zinc oxide are frequently used for materials of the transparent conductive electrode layers but not limited to the materials mentioned herein. The light shuttle film 12 also can be an electrochromism film, a suspended particle device, a Micro-blinds device or a liquid crystal device.

The heat insulating film structure 14 is arranged on one outer surface of the light shuttle film 12, wherein the heat insulating film structure 14 comprises a heat insulating layer 141 and an adhesive layer 142; the adhesive layer 142 is arranged on one surface of the heat insulating layer 141, whereby the whole heat insulating film structure 14 can be attached to the outer surface of the light shuttle film 12, wherein the adhesive layer 142 can be a pressure sensitive adhesive so as to scrape off particulates and sand attached thereon to provide better construction quality. In one embodiment, the heat insulating film structure 14 can be coated with different sorts of metal layers for generating different heat insulating effects and different looks of reflection, color and luster effects.

The attached layer 16 is arranged on another outer surface of the light shuttle film 12, thereby attaching the whole smart film structure 10 to the doors and windows, glass curtain walls, greenhouses, indoor partition walls, screen partitions or showcases and so on. In one embodiment, materials of the attached layer 16 are plastic film materials.

Continuing the above description, when the light shuttle film 12, which is a PDLC film, is under low driving voltage of the transparent conductive electrode, it will change from strong scattering opaque state to clear transparent state. When the driving voltage is removed (i.e. normal condition), the light shuttle film 12 will change from clear transparent state to strong scattering opaque state.

In the present invention, design for the attached layer 16 enables the whole smart film structure 10 directly attached to transparent objects (e.g. transparent glass), wherein transparency of the transparent glass can be changed freely by adjusting transparency of the light shuttle film 12. For example, when the light shuttle film 12 is in strong scattering opaque state, the transparent glass acts as ground glass; when the light shuttle film is in clear transparent state, the transparent glass remains transparent as usual. Additionally, the heat insulating film structure 14 can effectively insulate against thermal radiation and thermal transmission, for lowering indoor temperature or reducing the use of air conditioners to decrease expenditure on air conditioning equipment with the effect of energy conservation. Also in a embodiment, choosing proper materials for the heat insulating layer 141 enables the heat insolating film structure 14 to protect human skin and indoor furniture from being damaged by UV light.

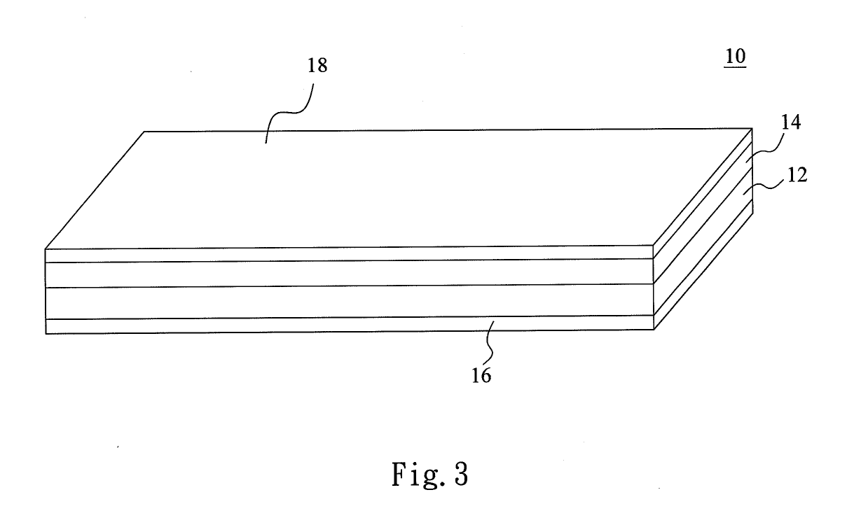

On the other side, FIG. 3 is a structure schematic diagram of a smart film structure according to another embodiment of the present invention. In this embodiment, the smart film structure 10 further comprises an anti-glare layer 18, which is arranged on the outer surface of the heat insulating film structure 14 but not limited to the description herein. The anti-glare layer 18 also can be arranged between the heat insulating film structure 14 and the light shuttle film 12, whereby eye discomfort caused by sunlight exposure can be prevented when the smart film structure 10 is attached to doors and windows or glass curtain walls. In one embodiment, the smart film structure further comprises an anti-reflection layer arranged on the outer surface of the heat insulating film structure or arranged between the heat insulating film structure and the light shuttle film, otherwise the anti-reflection layer and the anti-glare layer are stacked on each other, for enhancing light transmission rate of the light shuttle film to have better transparency. When the smart film structure is attached to doors and windows or glass curtain walls, there will be better indoor lighting and therefore reduces electricity consumption for lighting, which is in line with environmental consciousness.

In light of the description above, a smart film structure of the present invention can be directly attached to transparent glass. Transparency of the transparent glass can be changed freely by adjusting transparency of the light shuttle film with the advantages of blocking sight from outside viewers and protecting privacy; design for the heat insulating film can effectively insulate against thermal source, thereby lowering indoor temperature or reducing the use of air conditioners with the advantage of energy conservation.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A smart film structure comprising:
a light shuttle film comprising two opposite surfaces; and
a heat insulating film structure and an attached layer separately arranged on the two opposite surfaces of the light shuttle film.

2. The smart film structure according to claim 1, wherein the heat insulating film structure comprises: a heat insulating layer; and an adhesive layer arranged thereon that the heat insulating film structure is arranged on the light shuttle film by the adhesive layer.

3. The smart film structure according to claim 2, wherein the adhesive layer is a pressure sensitive adhesive.

4. The smart film structure according to claim 1, wherein the heat insulating film structure is coated with metal layer, for changing color and luster of the heat insulating film structure.

5. The smart film structure according to claim 1, wherein the light shuttle film is a polymeric dispersed liquid crystal film, an electrochromism film, a suspended particle device, a Micro-blinds device or a liquid crystal device.

6. The smart film structure according to claim 5, wherein the polymeric dispersed liquid crystal film comprises:
two transparent substrates, which are a first substrate and a second substrate arranged separately;
two transparent conductive electrode layers respectively arranged on the two opposite inner surfaces of the first substrate and the second substrate; and
polymeric dispersed liquid crystal, arranged between the first substrate and the second substrate.

7. The smart film structure according to claim 1 further comprising an anti-glare layer, arranged on the outer surface of the heat insulating film structure or arranged between the heat insulating film structure and the light shuttle film.

8. The smart film structure according to claim 1 further comprising an anti-reflection layer, arranged on the outer surface of the heat insulation film structure or arranged between the heat insulating film structure and the light shuttle film.

9. The smart film structure according to claim 1 further comprising an anti-glare layer and an anti-reflection layer, which are stacked on each other and arranged on the outer surface of the heat insulating film structure or arranged between the heat insulating film structure and the light shuttle film.

10. The smart film structure according to claim 1, wherein materials of the attached layer are plastic film materials.
